(19) United States
(12) Patent Application Publication
(10) Pub. No.: US 2014/0059844 A1
(43) Pub. Date: Mar. 6, 2014

(54) METHOD FOR MANUFACTURING GEL LITHIM BATTERY

(71) Applicants: CHIN-HUANG TSAI, Hsinchu City (TW); Chih-Hung Shen, Hsinchu City (TW); Der-Shiuh Shy, Hsinchu City (TW); Xue-Kun Xing, Hsinchu City (TW)

(72) Inventors: CHIN-HUANG TSAI, Hsinchu City (TW); Chih-Hung Shen, Hsinchu City (TW); Der-Shiuh Shy, Hsinchu City (TW); Xue-Kun Xing, Hsinchu City (TW)

(21) Appl. No.: 13/596,424

(22) Filed: Aug. 28, 2012

(51) Int. Cl. H01M 6/00

(52) U.S. Cl. 29/623.1

(57) ABSTRACT

A method for manufacturing a gel lithium battery is provided. The method includes steps of: fabricating a core device; placing the core device in a bag and injecting a reactive electrolyte into the bag; pre-charging the core device and the reactive electrolyte to cause chemical reactions of the core device and the reactive electrolyte; performing a heating process on the bag to cause a gel formation and aging of the reactive electrolyte; and performing an activation procedure on the core device and the reactive electrolyte in the bag to complete manufacturing the gel lithium battery. By pre-charging the core device and the reactive electrolyte, a structure of the core device is prevented from damages caused by expansion due to the heating and gel formation. The gel lithium battery disclosed offers enhanced quality and life cycle as well as low costs and high stability.

### FIELD OF THE INVENTION

The present invention relates to a method for manufacturing a lithium battery, and particularly to a method for manufacturing a gel lithium battery.

### BACKGROUND OF THE INVENTION

Portable electronic devices, including mobile phones, portable computers, tablet computers, MP3 and other portable media players, are necessities in the modern life. In order to render portability for the above electronic devices, a secondary battery is required for powering the portable electronic devices. Along with the miniaturization trend of electronic components, a size of the secondary battery becomes a critical factor that significantly affects an overall volume of a portable electronic device. The quality of a secondary battery determines a battery capacity, a total number of charge-discharge, a volume and a weight of the battery. Being immune from memory effects, small in size and affordable, a lithium secondary battery is a focus drawing much attention in the battery field.

To reduce a package size and optimize an outer volume of a lithium secondary battery, an aluminum foil is laminated into a bag-like structure as a housing for packaging the lithium secondary battery. However, the mechanical strength of the aluminum foil bag is far less than the strength of previously employed metal cans, such that a liquid leakage issue is resulted in various experiments testing for the mechanical strength. As a solution to the above liquid leakage issue, a gel lithium secondary battery is recently proposed by lithium battery manufacturers. In a gel lithium secondary battery, a prior liquid electrolyte is converted into a gel electrolyte for not only preventing liquid leakage but also enhancing capabilities for passing various safety tests of a finished battery product.

Among gel lithium batteries, polymer batteries prevail in miniaturization due to the solution for liquid leakage and enhanced safety contributed by the polymer electrolyte. The above gel lithium battery is successfully launched by Sony. A specially manufactured electrolyte and a polymer plastic material are finely applied onto a plate, which is rolled into a core device with an isolation film and directly placed in an aluminum foil bag without additionally injecting an electrolyte. The structure then becomes a battery after packaging and activation. However, the manufacturing process for above battery requires precision equipments. Further, except the manufacturing process for the plate, remaining related manufacturing processes can only be carried out in a total-dry chamber having extremely low humidity. As a result, the manufacturing process of the above gel lithium battery is not only complex but costly.

Another formula of a gel electrolyte is disclosed by the prior art. The formula includes a liquid electrolyte, at least one polymer monomer and at least one initiator. By cooperating the package housing and core device in the current technique, the above formula solves the complex and costly manufacturing process of common gel lithium batteries. Yet, product competitiveness can be further enhanced to increase product values if a charge-discharge life cycle and quick-discharge quality of the gel lithium battery are further improved.

### SUMMARY OF THE INVENTION

Therefore the primary object of the present invention is to improve the product quality of a gel lithium battery for satisfying market needs.

To achieve the above object, a method for manufacturing a gel lithium battery is provided by the present invention. The method includes the steps below.

In Step S1, a core device is fabricated.

In Step S2, the core device is placed in a bag, and a reactive electrolyte is injected into the bag.

In Step S3, the core device and the reactive electrolyte in the bag are pre-charged.

In Step S4, a heating process is performed on the bag to cause a gel formation and aging of the reactive electrolyte.

In Step S5, an activation procedure is performed on the core device and the reactive electrolyte in the bag.

In Step S6, the manufacturing process is completed.

It should be noted that, in the event that the structure of the core device is temporarily fixed due to the heating process and the gel formation, the core device may expand to become structurally loosened after charging the battery, in a way that the structure of the core device and chemical properties of the reactive electrolyte are damaged. As illustrated in the above description, in the present invention, to prevent the above issue, the core device and the reactive electrolyte in the bag are pre-charged to first cause chemical reactions before performing the heating process and the gel formation. Therefore, the present invention is capable of increasing the quality and a life cycle of the gel lithium battery, so as to fulfill user needs as well as to maintain low costs and high stability for optimizing product competitiveness.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of steps of a process according to one embodiment of the present invention.

FIG. 2 is a schematic diagram of a micellar unit according to one embodiment of the present invention.

FIGS. 3A and 3B are schematic diagrams comparing discharge speeds of a conventional solution and the present invention.

FIGS. 4A and 4B are schematic diagrams comparing battery life cycles of a conventional solution and the present invention.

FIGS. 5A and 5B are schematic diagrams comparing temperature effects of a conventional solution and the present invention.

### DETAILED DESCRIPTION OF THE PREFERRED EMBODIMENTS

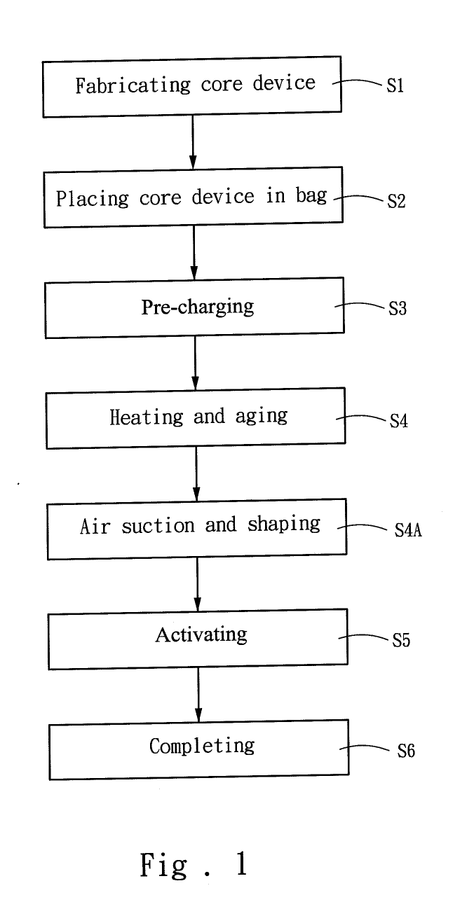

FIG. 1 shows a process for manufacturing a gel lithium battery according to one embodiment of the present invention.

In Step S1, a core device is fabricated. The core device comprises a positive terminal, a negative terminal and an isolation film disposed between the positive and negative terminals, and may be fabricated in a rolled form or a stacked form as desired based on actual needs. It should be noted that, details for fabricating the core device are not technical characteristics of the present invention, and shall not further described.

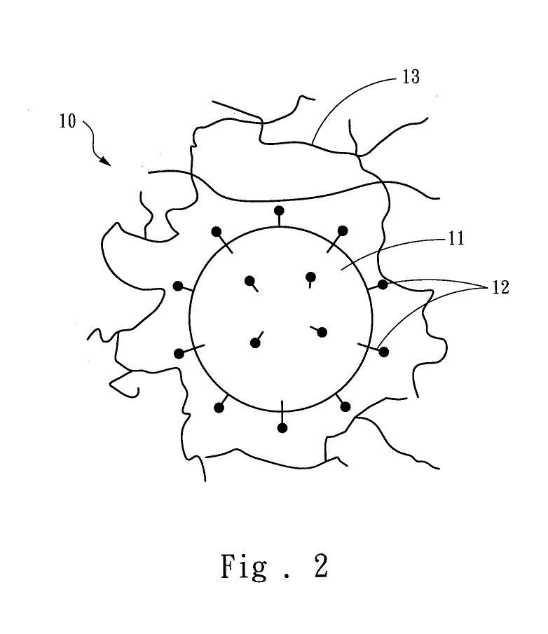

In Step S2, the core device is placed in a bag, and a reactive electrolyte is injected into the bag. For example, the bag is an aluminum foil bag including a flexible packaging material such as a Non-Oriented Cast Polypropylene film (CPP) and nylon, which features thin and light properties. The reactive electrolyte is a liquid, and transforms to a colloid after catalyzing and aging. In this embodiment, the reactive electrolyte comprises a liquid electrolyte, a polymer monomer and an initiator. The liquid electrolyte comprises a mixture of a carbonate and a salt. The carbonate may be two or more selected from propylene carbonate (PC), ethylene carbonate (EC), diethyl carbonate (DEC), dimethyl carbonate (EMC), and ethyl methyl carbonate (EMC). The salt may be LiPF₆ (0.9M˜1.5M) or LiBF₄ (0.9M˜1.5M). The polymer monomer may be a monofunctional polymer monomer, a multifunctional polymer monomer, and/or a multifunctional polymer monomer. The initiator may be an initiator with free radicals, e.g., benzoyl Peroxide (BPO) or azobisisobutyronitrile (AIBN). A weight ratio of the liquid electrolyte, the polymer monomer and the initiator is 50˜98.9%:1˜49.9%:0.1˜5%. The reactive electrolyte is thus completed as described. FIG. 2 shows another form for fabricating the reactive electrolyte. The reactive electrolyte in FIG. 2 comprises a plurality of micellar units 10. Each micellar unit 10 comprises an electrolytic micro-droplet 11 and a plurality of surfactant monomers 12 adhered to a surface of the electrolytic micro-droplet 11. The micellar unit 10 further comprises a plurality of polymer monomers 13 formed in an interlinking structure surrounding peripheries of the surfactant monomers 12, thereby forming the reactive electrolyte. More specifically, after injecting the reactive electrolyte, the core device and the reactive electrolyte are placed still for 6 to 72 hours to allow the reactive electrolyte to be evenly distributed on the core device.

In Step S3, a pre-charge process is performed. The core device and the reactive electrolyte in the bag are pre-charged to first cause chemical reactions between the core device and the reactive electrolyte. Preferably, the pre-charge process is performed to reach 40 to 80% of total cell capacity. The time for charging is controlled according to a charge speed and a size of the cell capacity.

In Step S4, a heating and aging process is performed. The bag is heated to cause a gel formation and aging of the liquid reactive electrolyte. A temperature of the heating is controlled between 40 to 90 degrees Celsius for a period of 10 minutes to 9 hours. Preferably, a battery with preferred quality can be formed with a heating temperature controlled between 60 to 80 degrees Celsius.

In Step S4A, air suction and shaping are performed. After confirming that desired electric pre-charging is achieved, air in the bag is sucked to attain vacuum and thus shaping the bag.

In Step S5, an activation procedure is performed. An activation procedure is performed on the core device and the reactive electrolyte in the bag. In this step, the core device and the reactive electrolyte are charged to reach a full electric capacity.

In Step S6, the manufacturing process is completed. The electric power of the battery is confirmed to complete the manufacturing process.

To compare the gel lithium battery manufactured by the method of the present invention and that of other conventional manufacturing methods, an embodiment of the manufacturing method of the present invention and an embodiment of a conventional manufacturing method shall be described in detail below. In both the embodiments, the positive terminals are made of LiCoO₂ or LiNiCoMnO₂ the negative terminals are made of graphite, and the same reactive electrolyte is used in the manufacturing processes. A difference in the embodiment of the present invention is that, the pre-charge step is performed before the heating and aging process; whereas the embodiment of the conventional solution directly performs the heating and aging process after injecting the reactive electrolyte, followed by performing the activation procedure.

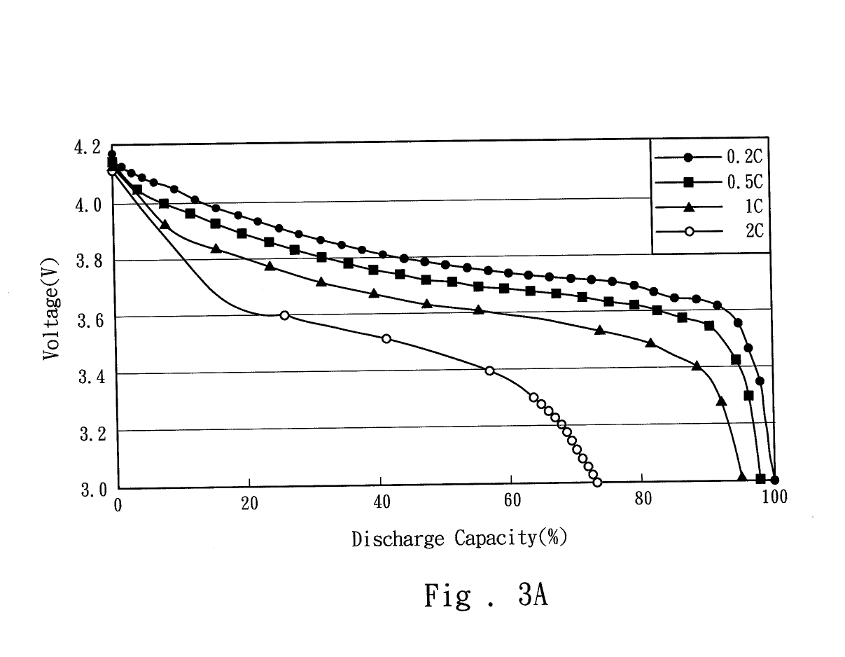

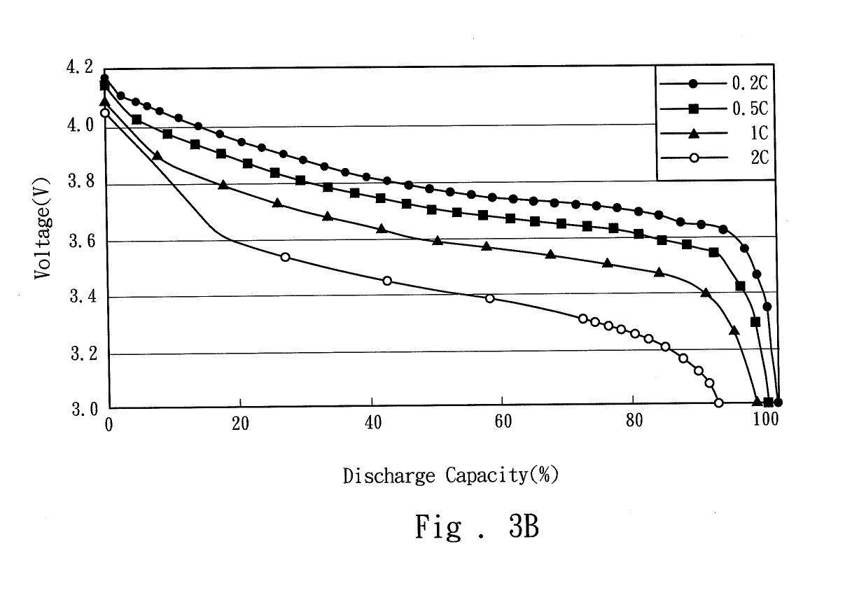

FIG. 3A shows a schematic diagram of a discharge speed of the embodiment of the conventional solution; FIG. 3B shows a schematic diagram of a discharge speed according to the embodiment the present invention. In the diagrams, 1 C represents a magnitude of a discharge current of fully discharging the battery in one hour, 2 C represents a magnitude of a discharge current of fully discharging the battery in half an hour, 0.5 C represents a magnitude of a discharge current of fully discharging the battery in two hours, 0.2 C represents a magnitude of a discharge current of fully discharging the battery in one hour, and so forth. It is apparent that, at a same voltage, the discharge capacity of the battery gets lower as the discharge speed gets faster, such that the voltage and the discharge capacity become inappropriately proportioned. Thus, an error in the electric power displayed is resulted to lead to a failure in correctly estimating a remaining electric capacity of the battery through the voltage. Under the conditions of 2 C with a 3V voltage, the discharge capacity reaches as high as above 90% in FIG. 3B, whereas the discharge capacity in FIG. 3A is less than 80%. Similarly, under other discharge conditions, the charge capacities based on the embodiment of the present invention are higher than those based on the embodiments of the conventional solution.

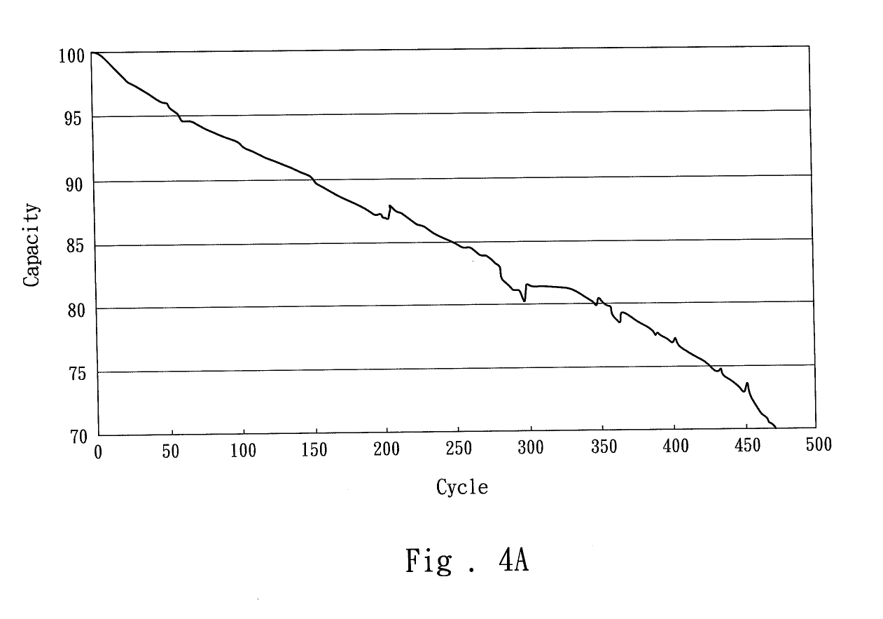

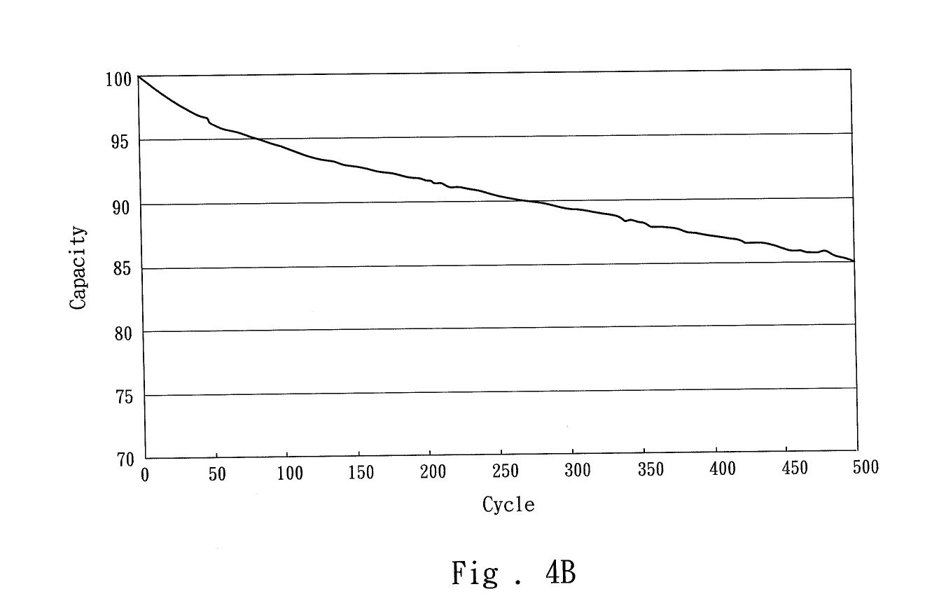

FIG. 4A shows a schematic diagram of a life cycle of a battery of the embodiment of the conventional solution; FIG. 4B shows a schematic diagram of a life cycle of a battery according to the embodiment of the present invention. In both diagrams, under the conditions of 0.5 C, a high-temperature environment of 45 degrees Celsius and after 500 times of charge-discharge, the battery capacity of the embodiment of the conventional solution is less than 70% as shown in FIG. 4A, whereas the battery capacity according to the embodiment of the present invention remains high at 85% as shown in FIG. 4B. Hence, it is obvious that the battery quality manufactured by the present invention is greatly preferred over the embodiment of the conventional solution. Further, the quality of the gel lithium battery can be compared favorably with the currently available mature liquid lithium battery.

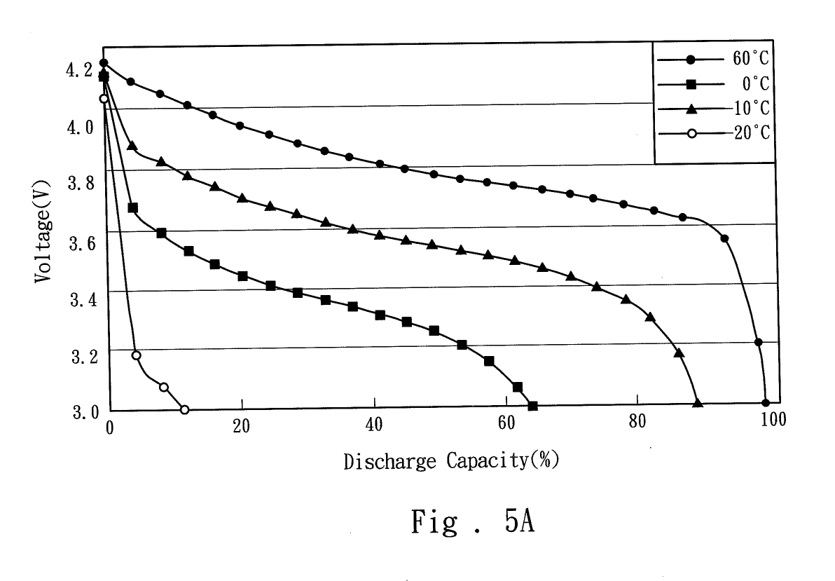

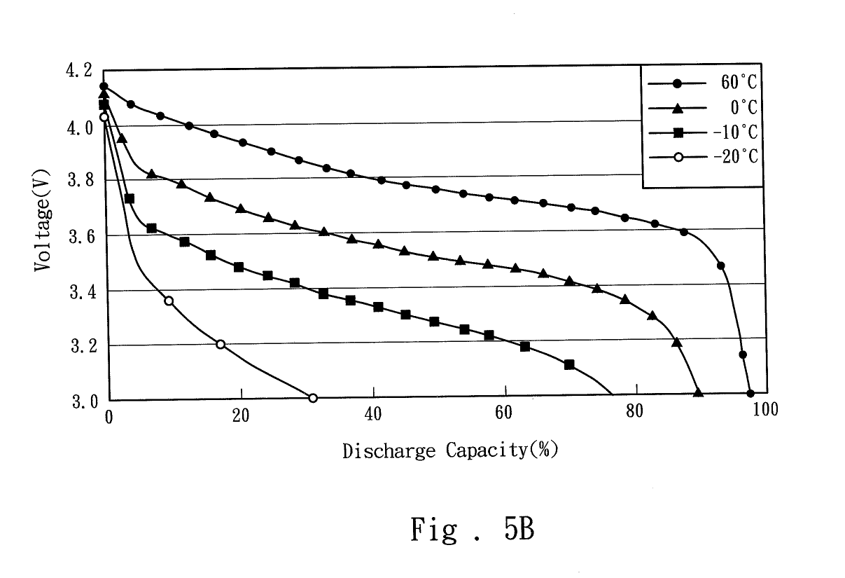

FIG. 5A shows a schematic diagram of temperature effects of the embodiment of the conventional solution; FIG. 5B shows a schematic diagram of temperature effects according to the embodiment of the present invention. The voltage and discharge capacity of the battery become more inappropriately proportioned as the ambient temperature gets lower. Under discharging conditions of 0.5 C in a−20% environment and a measuring voltage of 3V, the discharge capacity in FIG. 5A is as low as 10%, whereas the discharge capacity in FIG. 5B is still over 30%. Under other temperature conditions, the discharge capacities in FIG. 5B remain superior to that in FIG. 5A.

The method of the present invention offers numerous advantages. First of all, as previous sated, in the event that the structure of the core device is temporarily fixed due to the heating process and the gel formation, the core device may expand to become structurally loosened after charging the battery, in a way that the structure of the core device and chemical properties of the reactive electrolyte are damaged. Therefore, the present invention pre-charges the core device and the reactive electrolyte in the bag before performing the heating process and the gel formation, thereby preventing the above issue. Secondly, as proven by experimental results, the present invention offers high discharge stability, high temperature stability and a longer life cycle. By employing the conventional liquid electrolyte cooperating with the reactive electrolyte formed by the polymer monomer and initiator, the present invention is further advantaged by being low-cost as well as having a simple manufacturing process. In addition, the present invention further reduces manufacturing costs since the gel lithium battery can be completed with heating instead of requiring complex and costly equipments. Furthermore, the gel lithium battery features high safety.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for manufacturing a gel lithium battery, comprising:
S1) fabricating a core device;
S2) placing the core device in a bag, and injecting a reactive electrolyte into the bag;
S3) pre-charging the core device and the reactive electrolyte in the bag;
S4) performing a heat drying process on the bag to cause a colloid formation and aging of the reactive electrolyte;
S5) performing an activation procedure on the core device and the reactive electrolyte in the bag; and
S6) completing the gel lithium battery.

2. The method of claim 1, wherein the reactive electrolyte comprises a liquid electrolyte, a polymer monomer and an initiator.

3. The method of claim 2, wherein a weight ratio of the liquid electrolyte, the polymer monomer and the initiator is 50˜98.9%:1˜49.9%:0.1˜5%.

4. The method of claim 2, wherein the polymer monomer is selected from a group consisting of a monofunctional polymer monomer, a multifunctional polymer monomer and a multifunctional acrylic monomer, and the initiator is an initiator having free radicals.

5. The method of claim 4, wherein the initiator is selected from a group consisting of benzoyl Peroxide (BPO) or azobisisobutyronitrile (AIBN).

6. The method of claim 1, wherein the reactive electrolyte comprises a plurality of micellar units, and each of the plurality of micellar unit comprises an electrolytic micro-droplet and a plurality of surfactant monomers adhered to a surface of the electrolytic micro-droplet.

7. The method of claim 6, wherein each of the plurality of micellar units further comprises a plurality of polymer monomers formed in an interlinking structure surrounding peripheries of the plurality of surfactant monomers.

8. The method of claim 1, wherein the step (S2), after injecting the reactive electrolyte, comprises placing the core device and the reactive electrolyte still for 6 to 72 hours to allow the reactive electrolyte to be evenly distributed on the core device.

9. The method of claim 1, wherein the step (S3) comprises pre-charging the core device and the reactive electrolyte till reaching 40 to 80% of a total cell capacity.

10. The method of claim 1, wherein the step (S4) comprises controlling a temperature of heat drying between 40 and 90 degrees Celsius for 10 minutes to 9 hours.

11. The method of claim 10, wherein the step (S4) comprises controlling the temperature of heat drying between 60 and 80 degrees Celsius.

12. The method of claim 1, wherein the step (S5) comprises charging the core device and the reactive electrolyte till the core device and the reactive electrolyte are fully charged.

13. The method of claim 1, between steps (S4) and (S5), further comprising:
S4A) sucking air out of the bag till the bag is vacuum to complete shaping.
